(19) United States
(12) Patent Application Publication
(10) Pub. No.: US 2026/0079361 A1
(43) Pub. Date: Mar. 19, 2026

(54) Thin Film Pockels Material-Based Photonics Structure Incorporating an Optoelectronic Device

(71) Applicant: Newport Fab, LLC dba Tower Semiconductor Newport Beach, Newport Beach, CA (US)

(72) Inventor: Edward Preisler, San Clemente, CA (US)

(21) Appl. No.: 18/889,266

(22) Filed: Sep. 18, 2024

(51) Int. Cl. G02F 1/035

(52) U.S. Cl. CPC G02F 1/035; G02F 2202/20

(57) ABSTRACT

A method of fabricating an optoelectronic device includes providing a semiconductor structure including a Pockels material layer situated over a first dielectric layer formed over a semiconductor layer, and forming a second dielectric layer over the Pockels material layer. The method further comprises forming an optoelectronic device layer over the second dielectric layer, and patterning the optoelectronic device layer to form the optoelectronic device. The Pockels material layer is configured to generate an electric field to modulate a performance of the optoelectronic device. In one implementation, an optoelectronic device structure is achieved by utilizing the above-described method.

### BACKGROUND

Optoelectronic devices are commonly used in data communications and other fields such as imaging and health care. Various applications of optoelectronic devices, such as modulators, interferometers, and optical switches, can make use of an electro-optical effect to produce changes in optical properties (such as phase, amplitude, wavelength, polarization and the like). In one approach, optoelectronic devices are formed from a layer of semiconductor material.

However, conventional semiconductor-based optoelectronic devices may not exhibit electro-optical effects as strongly as optoelectronic devices based on other materials. Moreover, conventional semiconductor-based optoelectronic devices may be less efficient, requiring relatively high power consumption in order to achieve a desired degree of change in optical properties. Integrating materials with stronger electro-optical effects often requires specialized processing, and may not be practical.

Thus, there is a need in the art for a solution enabling fabrication of optoelectronic devices with strong electro-optical effects without sacrificing manufacturing conveniences.

### SUMMARY

The present disclosure is directed to a thin film Pockels material-based photonics structure incorporating an optoelectronic device, substantially as shown in and/or described in connection with at least one of the figures, and as set forth in the claims.

### BRIEF DESCRIPTION OF THE DRAWINGS

FIG. 1 shows a flowchart presenting an exemplary method for fabricating a thin film Pockels material-based photonics structure incorporating an optoelectronic device, according to one implementation of the present application.

FIG. 2 shows a cross-sectional view of an exemplary photonics structure corresponding to an initial fabrication action according to the flowchart of FIG. 1.

FIG. 3 shows a cross-sectional view of the exemplary photonics structure of FIG. 2 at a subsequent fabrication action according to the flowchart of FIG. 1.

FIG. 4 shows a cross-sectional view of the exemplary photonics structure of FIG. 3 at a subsequent fabrication action according to the flowchart of FIG. 1.

FIG. 5 shows a cross-sectional view of the exemplary photonics structure of FIG. 4 at a subsequent fabrication action according to the flowchart of FIG. 1.

FIG. 6 shows a cross-sectional view of the exemplary photonics structure of FIG. 5 at a subsequent fabrication action according to the flowchart of FIG. 1.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

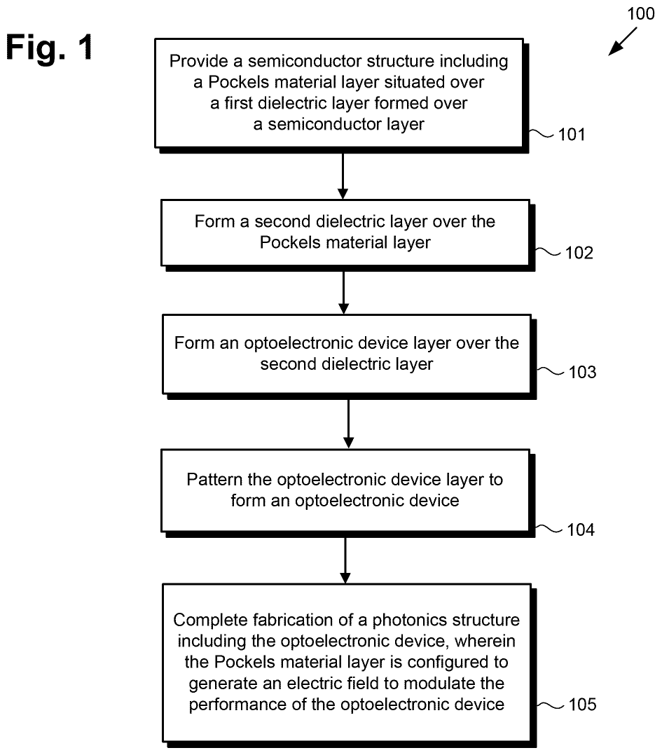

FIG. 1 illustrates flowchart 100 of an exemplary method for fabricating a thin film Pockels material-based photonics structure incorporating an optoelectronic device, according to one implementation of the present application. Actions 101 through 105 shown in flowchart 100 of FIG. 1 are sufficient to describe one implementation of the present inventive concepts. Other implementations of the present inventive concepts may utilize actions different from those shown in flowchart 100. Certain details and features have been left out of flowchart 100 that are apparent to a person of ordinary skill in the art. For example, an action may consist of one or more sub-actions or may involve specialized equipment or materials, as known in the art. Moreover, some actions, such as masking and cleaning actions, are omitted so as not to distract from the illustrated actions.

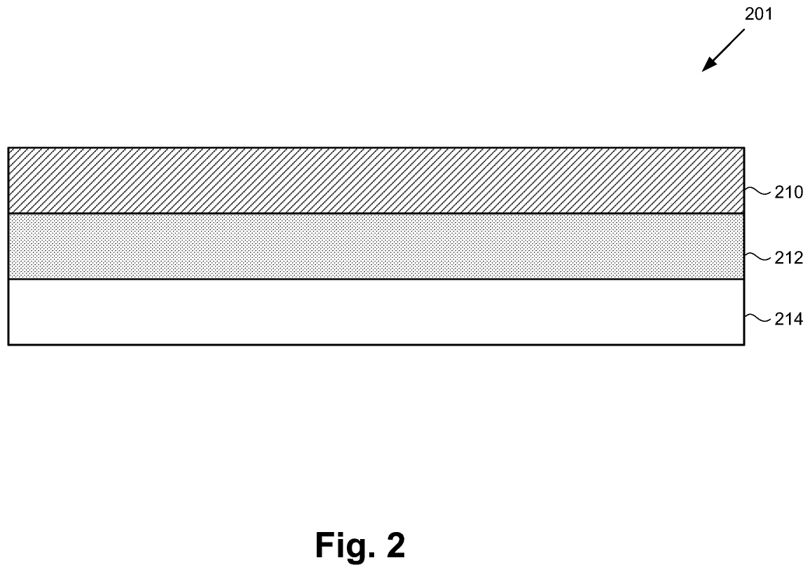

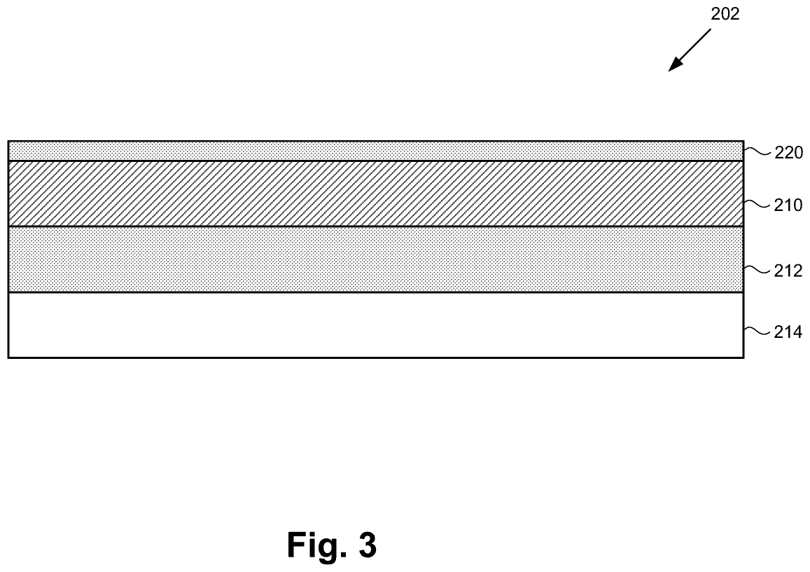

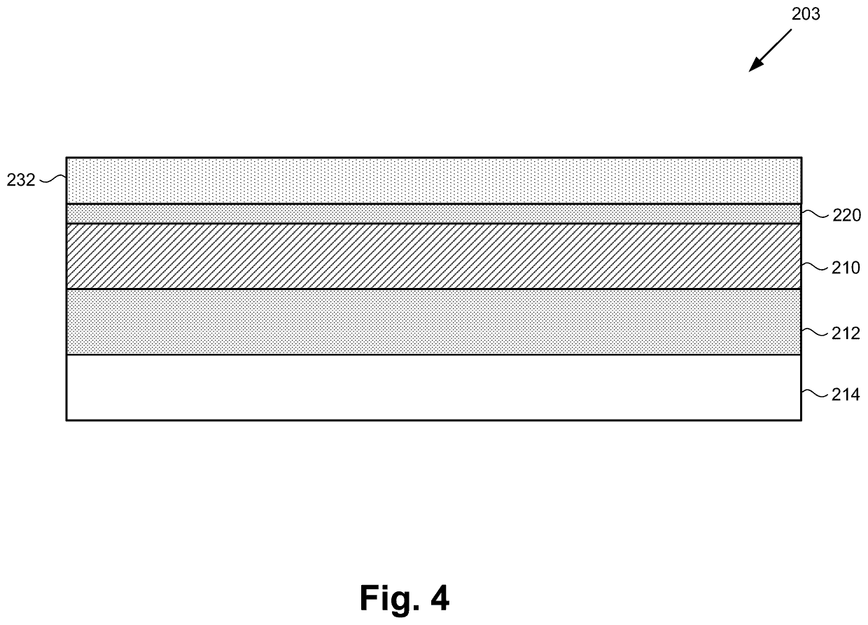

With respect to FIGS. 2, 3, 4, 5 and 6 (hereinafter “FIGS. 2-6”), photonics structures 201, 202, 203, 204 and 205 shown respectively in FIGS. 2-6 illustrate the result of performing the method of flowchart 100, according to one implementation. For example, FIG. 2 depicts a cross-sectional view of photonics structure 201 provided so as to include Pockels material layer 210 situated over first dielectric layer 212 formed over semiconductor layer 214 (action 101). Photonics structure 202, in FIG. 3, is a cross-sectional view of structure 201 after formation of second dielectric layer 220 over Pockels material layer 210 (action 102). Photonics structure 203, in FIG. 4, is a cross-sectional view of structure 202 after formation of optoelectronic device layer 232 over second dielectric layer 220 (action 103) and so forth.

It is noted that the cross-sectional photonics structures shown in FIGS. 2-6 are provided as specific implementations of the present inventive principles, and are shown with such specificity for the purposes of conceptual clarity. Consequently, particular details such as the materials used to form the cross-sectional photonics structures shown in FIGS. 2-6, as well as the techniques used to produce the various depicted features, are being provided merely as examples, and should not be interpreted as limitations.

Referring to flowchart 100 in FIG. 1 in combination with FIG. 2, flowchart 100 begins with providing a semiconductor structure, i.e., photonics structure 201, including Pockels material layer 210 formed over dielectric layer 212 (hereinafter “first dielectric layer 212”) formed over semiconductor layer 214 (action 101). By way of example, Pockels material layer 210 may be a lithium niobate (LiNbO3) layer or a barium titanate (BTO) layer.

It is noted that, as used in the present application, the feature described as a “Pockels material” refers to any material that exhibits the Pockels effect, whereby the refractive index of a medium changes in response to an applied electric field. In the present implementation, photonics structure 201 includes semiconductor layer 214 and first dielectric layer 212 supporting Pockels material layer 210. In various implementations, Pockels material layer 210 can comprise a thin film of LiNbO₃, BTO, lithium tantalate (LiTa), potassium dihydrogen phosphate (KDP), deuterated potassium dihydrogen phosphate (DKDP), rubidium titanyl phosphate (RTP), potassium titanyl phosphate (KTP), potassium titanyl arsenate (KTA), barium borate (BBO), ammonium dihydrogen phosphate (ADP), cadmium telluride (CdTe), various organic materials which demonstrate a strong Pockels effect, or any other suitable Pockels material. In various implementations, Pockels material layer 210 may have a thickness in a range from approximately three hundred nanometers to approximately five hundred nanometers (300 nm - 500 nm), for example, or greater or less.

Pockels material layer 210 is situated on first dielectric layer 212. In various implementations, first dielectric layer 212 can comprise silicon dioxide (SiO₂), silicon nitride (Si_{X}N_{Y}), silicon oxynitride (Si_{X}O_{Y}N_{Z}), or any other suitable dielectric. First dielectric layer 212 is formed over semiconductor layer 214. In various implementations, semiconductor layer 214 can comprise silicon, germanium, silicon-germanium, or any other suitable semiconductor material.

Semiconductor layer 214, first dielectric layer 212 and Pockels material layer 210 can be provided together in photonics structure 201 as a pre-fabricated structure in action 101. Alternatively, in some implementations photonics structure 201 may be provided in action 101 by being fabricated. For example first dielectric layer 212 may be deposited or thermally grown on semiconductor layer 214. Pockels material layer 210 may then be placed in contact with first dielectric layer 212 and may be fusion boded to first dielectric layer 212 through the application of heat, pressure, or the application of heat and pressure.

Moving to photonics structure 202 in FIG. 3, with continued reference to flowchart 100, in FIG. 1, flowchart 100 further includes forming second dielectric layer 220 over Pockels material layer 210 (action 102). Second dielectric layer 220 may comprise SiO₂, Si_{X}N_{Y}, Si_{X}O_{Y}N_{Z}, or any other suitable dielectric. Second dielectric layer 220 may be formed, in action 102, by being deposited, and planarized using chemical mechanical polishing (CMP) for example, to a thickness of approximately one hundred nanometers (100 nm), for example, or greater or less. It is noted that in some implementations, second dielectric layer 220 may be formed of the same dielectric material as first dielectric layer 212. For example, in one implementation, each of first dielectric layer 212 and second dielectric layer 220 may be or include a SiO₂ layer.

Turning to photonics structure 203 in FIG. 4, with continued reference to flowchart 100, in FIG. 1, flowchart 100 further includes forming optoelectronic device layer 232 over second dielectric layer 220 (action 103). Optoelectronic device layer 232 may be formed as a Si_{X}N_{Y} layer, such as a Si₃N₄ layer for example, characterized by low optical propagation losses at typical telecommunications wavelengths, such as wavelengths of 1310 nm to 1550 nm, and/or at visible wavelengths, such as wavelengths of 400 nm to 700 nm. Optoelectronic device layer 232 may be formed, in action 103, by being deposited, and planarized using CMP to have a thickness in a range from approximately three hundred nanometers to approximately five hundred nanometers (300 nm-500 nm), for example, or greater or less.

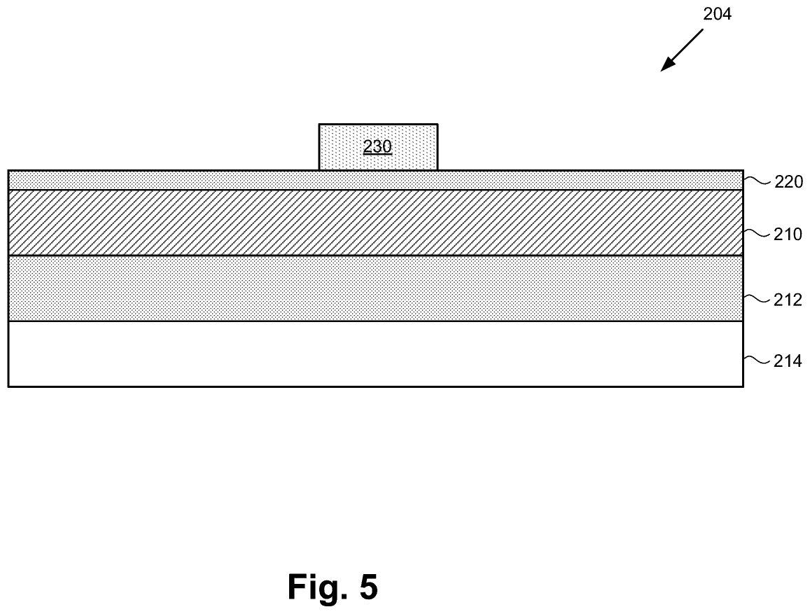

Moving to photonics structure 204 in FIG. 5, with continued reference to flowchart 100, in FIG. 1, flowchart 100 further includes patterning optoelectronic device layer 232 to form optoelectronic device 230 (action 104). In some implementations, optoelectronic device 230 may take the form of a Si_{X}N_{Y} waveguide, such as a Si₃N₄ waveguide for example. In implementations in which second dielectric layer 220 is a SiO₂ layer and optoelectronic device layer 232 is a Si_{X}N_{Y} layer, patterning of optoelectronic device layer 232, in action 104, may be performed using any suitable technique for removing Si_{X}N_{Y} while sparing SiO₂. In those implementations, for example, optoelectronic device layer 232 may be dry etched to form optoelectronic device 230. Alternatively, in some implementations in which second dielectric layer 220 is a SiO₂ layer and optoelectronic device layer 232 is a Si₃N₄ layer, optoelectronic device layer 232 may be plasma etched to form optoelectronic device 230 using a gas mixture that is highly selective for Si₃N₄. One example of such a gas mixture is a sulfur hexafluoride/methane/nitrogen/oxygen (SF₆/CH₄/N₂/O₂) mixture, for example.

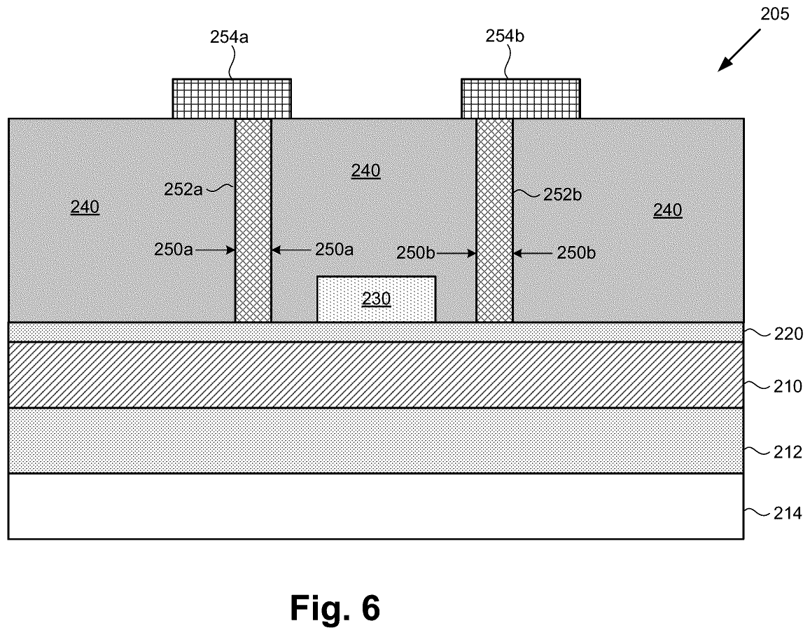

Turning to photonics structure 205 in FIG. 6, with continued reference to flowchart 100, in FIG. 1, flowchart 100 further includes completing fabrication of photonics structure 205 including optoelectronic device 230, where Pockels material layer 210 is configured to generate an electric field to modulate the performance of optoelectronic device 230 (action 105). As shown in FIG. 6, action 105 includes forming conformal interlayer dielectric 240 so as to cover second dielectric layer 220 and optoelectronic device 230.

In various implementations, conformal interlayer dielectric 240 can comprise borophosphosilicate glass (BPSG), tetra-ethyl ortho-silicate (TEOS), SiO₂, Si_{X}N_{Y}, Si_{X}O_{Y}N_{Z}, or another dielectric. Conformal interlayer dielectric 240 can be formed by being deposited, and planarized using CMP for example. Optoelectronic device 230 is situated in and under conformal interlayer dielectric 240. It is noted that although conformal interlayer dielectric 240 is illustrated as a single dielectric layer in FIG. 6, conformal interlayer dielectric 240 can be a combination of multiple dielectric layers.

Continuing to refer to FIGS. 1 and 6 in combination, action 105 further includes etching first contact opening 250a and second contact opening 250b in conformal interlayer dielectric 240 adjacent respective opposite sides of optoelectronic device 230. As shown by photonics structure 205, in FIG. 6, first and second contact openings 250a and 250b terminate on second dielectric layer 220 over Pockels material layer 210. In some implementations, for example, second dielectric layer 220 may serve as an etch stop layer for the formation of first and second contact openings 250a and 250b.

Continuing to refer to FIGS. 1 and 6 in combination, action 105 further includes forming first contact 252a in first contact opening 250a and second contact 252b in second contact opening 250b. Contacts 252a and 252b are situated in conformal interlayer dielectric 240. In one implementation, after first contact opening 250a and second contact opening 250b are etched in conformal interlayer dielectric 240, a metal is deposited into each of contact openings 250a and 250b, and then planarized with conformal interlayer dielectric 240, using CMP for example, thereby forming respective first contact 252a and second contact 252b. In an alternative implementation, a damascene process may be used to form first contact 252a and second contact 252b. In various implementations, first contact 252a and second contact 252b can comprise tungsten (W), aluminum (Al), or copper (Cu).

Continuing to refer to FIGS. 1 and 6 in combination, action 105 further includes forming first interconnect metal segment 254a and second interconnect metal segment 254b over conformal interlayer dielectric 240, first interconnect metal segment 254a being electrically coupled to first contact 252a and second interconnect metal segment 254b being electrically coupled to second contact 252b. In one implementation, a metal layer (not shown in FIG. 6) is deposited over conformal interlayer dielectric 240 and first and second contacts 252a and 252b, and then segments thereof are etched, thereby forming first interconnect metal segment 254a and second interconnect metal segment 254b. In an alternative implementation, a damascene process may be used to form first interconnect metal segment 254a and second interconnect metal segment 254b. In various implementations, first interconnect metal segment 254a and second interconnect metal segment 254b can comprise W, Al, or Cu.

It is noted that although first contact 252a and first interconnect metal segment 254a, as well as second contact 252b and second interconnect metal segment 254b, are illustrated as separate formations in FIG. 6, in other implementations they may be parts of the same formation. That is to say, first contact 252a and first interconnect metal segment 254a may be a single formation, and second contact 252b and second interconnect metal segment 254b may be another single formation. Moreover, it is further noted that photonics structure 205 can include other contacts and other interconnect metal segments not shown in FIG. 6.

Continuing to refer to FIGS. 1 and 6 in combination, in some implementations, the method outlined by flowchart 100 can conclude with action 105, described above. However, in some implementations, that method may further include applying a first voltage to first interconnect metal segment 254a and a second voltage to second interconnect metal segment 254b to capacitively couple first contact 252a to second contact 252b across conformal interlayer dielectric 240.

It is noted that Pockels material layer 210 is insulated from the first and second voltages applied to respective first and second interconnect metal segments 254a and 254b, by second dielectric layer 220 situated between first contact 252a and Pockels material layer 210 as well as between second contact 252a and Pockels material layer 210. Nevertheless, the capacitively coupling of first contact 252a to second contact 252b due to application of the first voltage to first interconnect metal segment 254a and application of the second voltage to second interconnect metal segment 254b generates an electrical field in Pockels material layer 210 that advantageously modulates the performance of optoelectronic device 230, such as a Si_{X}N_{Y} wave guide, situated over Pockels material layer 210 in photonics structure 205.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

1. A method of fabricating an optoelectronic device, said method comprising:
providing a semiconductor structure including a Pockels material layer situated over a first dielectric layer formed over a semiconductor layer;
forming a second dielectric layer over said Pockels material layer;
forming an optoelectronic device layer over said second dielectric layer;
patterning said optoelectronic device layer to form said optoelectronic device.

2. The method of claim 1, further comprising modulating a performance of said optoelectronic device by generating an electric field in said Pockels material layer.

3. The method of claim 1, wherein said optoelectronic device comprises a waveguide.

4. The method of claim 3, wherein said waveguide comprises silicon nitride (Si_{X}N_{Y}).

5. The method of claim 1, wherein said Pockels material layer is one of a lithium niobate (LiNbO3) layer or a barium titanate (BTO) layer.

6. The method of claim 1, wherein said Pockels material layer comprises a Pockels material selected from the group consisting of lithium niobate (LiNbO3), lithium tantalate (LiTa), potassium dihydrogen phosphate (KDP), deuterated potassium dihydrogen phosphate (DKDP), rubidium titanyl phosphate (RTP), potassium titanyl phosphate (KTP), potassium titanyl arsenate (KTA), barium borate (BBO), barium titanate (BTO), ammonium dihydrogen phosphate (ADP), and cadmium telluride (CdTe).

7. The method of claim 1, wherein said Pockels material layer has a thickness of greater than or equal to three hundred nanometers (300 nm) and less than or equal to five hundred nanometers (500 nm).

8. The method of claim 1, wherein said optoelectronic device layer has a thickness of greater than or equal to three hundred nanometers (300 nm) and less than or equal to five hundred nanometers (500 nm).

9. The method of claim 1, wherein said second dielectric layer has a thickness of approximately one hundred nanometers (100 nm).

10. The method of claim 1, wherein said first and second dielectric layers comprise silicon dioxide (SiO₂).

11. The method of claim 1, wherein said semiconductor layer comprises silicon (Si).

12. A photonics structure comprising:
a Pockels material layer situated over a first dielectric layer formed over a semiconductor layer;
a second dielectric layer formed over said Pockels material layer;
an optoelectronic device formed over said Pockels material layer;
wherein said Pockels material layer is configured to generate an electric field to modulate a performance of said optoelectronic device.

13. The photonics structure of claim 12, wherein said optoelectronic device comprises a waveguide.

14. The photonics structure of claim 13, wherein said waveguide comprises silicon nitride (Si_{X}N_{Y}).

15. The photonics structure of claim 12, wherein said Pockels material layer is one of a lithium niobate (LiNbO3) layer or a barium titanate (BTO) layer.

16. The photonics structure of claim 12, wherein said Pockels material layer comprises a Pockels material selected from the group consisting of lithium niobate (LiNbO3), lithium tantalate (LiTa), potassium dihydrogen phosphate (KDP), deuterated potassium dihydrogen phosphate (DKDP), rubidium titanyl phosphate (RTP), potassium titanyl phosphate (KTP), potassium titanyl arsenate (KTA), barium borate (BBO), barium titanate (BTO), ammonium dihydrogen phosphate (ADP), and cadmium telluride (CdTe).

17. The photonics structure of claim 12, wherein said Pockels material layer has a thickness of greater than or equal to three hundred nanometers (300 nm) and less than or equal to five hundred nanometers (500 nm).

18. The photonics structure of claim 12, wherein said second dielectric layer has a thickness of approximately one hundred nanometers (100 nm).

19. The photonics structure of claim 12, wherein said first and second dielectric layers comprise silicon dioxide (SiO₂).

20. The photonics structure of claim 12, wherein said semiconductor layer comprises silicon (Si).
